(19) United States
(12) Patent Application Publication
(10) Pub. No.: US 2007/0143582 A1
(43) Pub. Date: Jun. 21, 2007

(54) System and method for grouping execution threads

(75) Inventors: Brett W. Coon, San Jose, CA (US); John Erik Lindholm, Saratoga, CA (US)

Correspondence Address: PATTERSON & SHERIDAN, L.L.P., 3040 POST OAK BOULEVARD, SUITE 1500, HOUSTON, TX, 77056, US

(73) Assignee: NVIDIA Corporation

(21) Appl. No.: 11/305,558

(22) Filed: Dec. 16, 2005

(51) Int. Cl. G06F 15/00

(52) U.S. Cl. 712/235

(57) ABSTRACT

Multiple threads are divided into buddy groups of two or more threads, so that each thread has assigned to it one or more buddy threads. Only one thread in each buddy group actively executes instructions and this allows buddy threads to share hardware resources, such as registers. When an active thread encounters a swap event, such as a swap instruction, the active thread suspends execution and one of its buddy threads begins execution using that thread's private hardware resources and the buddy group's shared hardware resources. As a result, the thread count can be increased without replicating all of the per-thread hardware resources.

### BACKGROUND OF THE INVENTION

1. Field of the Invention

Embodiments of the present invention relate generally to multi-threaded processing and, more particularly, to a system and method for grouping execution threads to achieve improved hardware utilization.

2. Description of the Related Art

In general, computer instructions require multiple clock cycles to execute. For this reason, multi-threaded processors execute parallel threads of instructions in a successive manner so that the hardware for executing the instructions can be kept as busy as possible. For example, when executing the thread of instructions having the characteristics shown below, a multi-threaded processor may schedule four parallel threads in succession. By scheduling the threads in this manner, the multi-threaded processor is able to complete execution of 4 threads after 23 clock cycles, with the first thread being executed during clock cycles 1-20, the second thread being executed during clock cycles 2-21, the third thread being executed during clock cycles 3-22, and the fourth thread being executed during clock cycles 4-23. By comparison, if the processor did not schedule a thread until a thread in process completed execution, it would have taken 80 clock cycles to complete the execution of 4 threads, with the first thread being executed during clock cycles 1-20, the second thread being executed during clock cycles 21-40, the third thread being executed during clock cycles 41-60, and the fourth thread being executed during clock cycles 61-80.

| Instruction | Latency | Resource Required |
|---|---|---|
| 1 | 4 clock cycles | 3 registers |
| 2 | 4 clock cycles | 4 registers |
| 3 | 4 clock cycles | 3 registers |
| 4 | 4 clock cycles | 5 registers |
| 5 | 4 clock cycles | 3 registers |

The parallel processing described above, however, requires a greater amount of hardware resources, e.g., a larger number of registers. In the example given above, the number of registers required for the parallel processing is 20, compared with 5 for the non-parallel processing.

In many cases, the latency of execution is not uniform. For example, in the case of graphics processing, a thread of instructions typically include math operations that often have latencies that are less than 10 clock cycles and memory access operations that have latencies that are in excess of 100 clock cycles. In such cases, scheduling the execution of parallel threads in succession does not work very well. If the number of parallel threads executed in succession is too small, much of the execution hardware becomes under-utilized as a result of the high latency memory access operation. If, on the other hand, the number of parallel threads executed in succession is made large enough to cover the high latency of the memory access operation, the number of registers required to support the live threads would increase significantly.

### SUMMARY OF THE INVENTION

The present invention provides a method for grouping execution threads so that the execution hardware is utilized more efficiently. The present invention also provides a computer system that includes a memory unit that is configured to group execution threads so that the execution hardware is utilized more efficiently.

According to an embodiment of the present invention, multiple threads are divided into buddy groups of two or more threads, so that each thread has assigned to it one or more buddy threads. Only one thread in each buddy group is actively executing instructions. When an active thread encounters a swap event, such as a swap instruction, the active thread suspends execution and one of its buddy threads begins execution.

The swap instruction typically appears after a high latency instruction, and causes the currently active thread to be swapped for one of its buddy threads in the active execution list. The execution of the buddy thread continues until the buddy thread encounters a swap instruction, which causes the buddy thread to be swapped for one of its buddy threads in the active execution list. If there are only two buddies in a group, the buddy thread is swapped for the original thread in the active execution list, and the execution of the original thread resumes. If there are more than two buddies in a group, the buddy thread is swapped for the next buddy in the group according to some predetermined ordering.

To conserve register file usage, each buddy thread has its register allocation divided into two groups: private and shared. Only registers that belong to the private group retain their values across swaps. The shared registers are always owned by the currently active thread of the buddy group.

The buddy groups are organized using a table that is populated with threads as the program is loaded for execution. The table may be maintained in an on-chip register. The table has multiple rows and is configured in accordance with the number of threads in each buddy group. For example, if there are two threads in each buddy group, the table is configured with two columns. If there are three threads in each buddy group, the table is configured with three columns.

The computer system, according to an embodiment of the present invention, stores the table described above in memory and comprises a processing unit that is configured with first and second execution pipelines. The first execution pipeline is used to carry out math operations and the second execution pipeline is used to carry out memory operations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified block diagram of a computer system implementing a GPU with a plurality of processing units in which the present invention may be implemented.

FIG. 2 illustrates a processing unit in FIG. 1 in additional detail.

FIG. 3 is a functional block diagram of an instruction dispatch unit shown in FIG. 2.

FIG. 4 is a conceptual diagram showing a thread pool and an instruction buffer according to a first embodiment of the present invention.

FIG. 5 is a conceptual diagram showing a thread pool and an instruction buffer according to a second embodiment of the present invention.

FIG. 6 is a timing diagram that illustrates the swapping of active execution threads between buddy threads.

FIG. 7 is a flow diagram that illustrates the process steps carried out by a processing unit when executing buddy threads.

### DETAILED DESCRIPTION

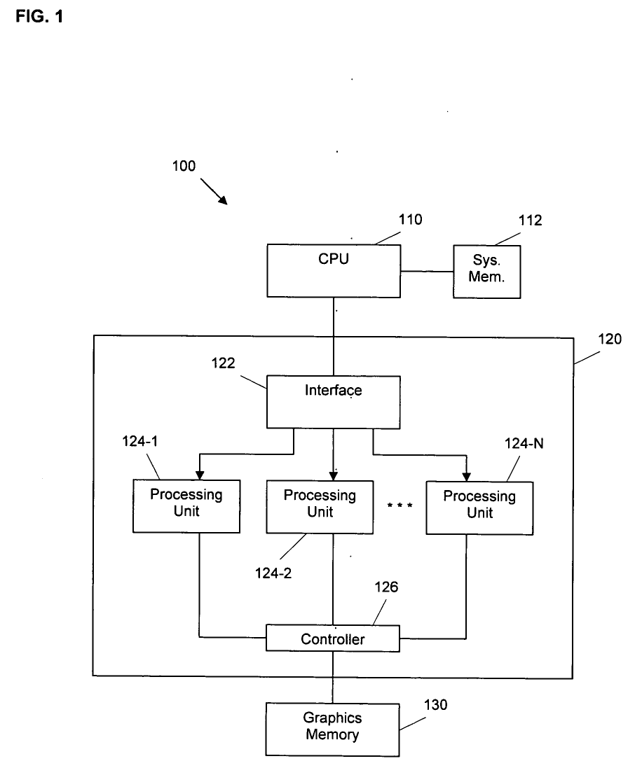

FIG. 1 is a simplified block diagram of a computer system 100 implementing a graphics processing unit (GPU) 120 with a plurality of processing units in which the present invention may be implemented. The GPU 120 includes an interface unit 122 coupled to a plurality of processing units 124-1, 124-2, . . . , 124-N, where N is an integer greater than 1. The processing units 124 have access to a local graphics memory 130 through a memory controller 126. The GPU 120 and the local graphics memory 130 represent a graphics subsystem that is accessed by a central processing unit (CPU) 110 of the computer system 100 using a driver that is stored in a system memory 112.

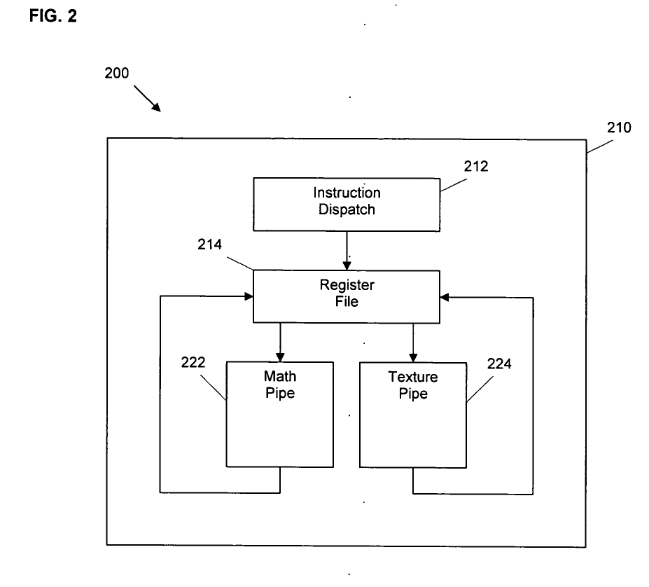

FIG. 2 illustrates one of the processing units 124 in additional detail. The processing unit illustrated in FIG. 2, referenced herein as 200, is representative of any one of the processing units 124 shown in FIG. 1. The processing unit 200 includes an instruction dispatch unit 212 for issuing an instruction to be executed by the processing unit 200, a register file 214 that stores the operands used in executing the instruction, and a pair of execution pipelines 222, 224. The first execution pipeline 222 is configured to carry out math operations, and the second execution pipeline 224 is configured to carry out memory access operations. In general, the latency of instructions executed in the second execution pipeline 224 is much higher than the latency of instructions executed in the first execution pipeline 222. When the instruction dispatch unit 212 issues an instruction, the instruction dispatch unit 212 sends pipeline configuration signals to one of the two execution pipelines 222, 224. If the instruction is of the math type, the pipeline configuration signals are sent to the first execution pipeline 222. If the instruction is of the memory access type, the pipeline configuration signals are sent to the second execution pipeline 224. The execution results of the two execution pipelines 222, 224 are written back into the register file 214.

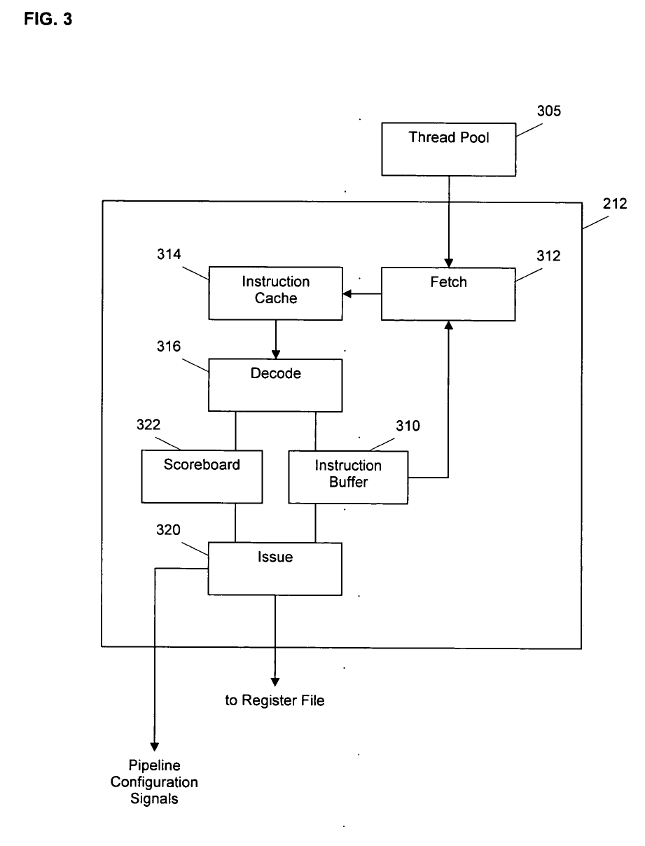

FIG. 3 is a functional block diagram of the instruction dispatch unit 212. The instruction dispatch unit 212 includes an instruction buffer 310 with a plurality of slots. The number of slots in this exemplary embodiment is 12 and each slot can hold up to two instructions. If any one of the slots has a space for another instruction, a fetch 312 is made from a thread pool 305 into an instruction cache 314. The thread pool 305 is populated with threads when a program is loaded for execution. Before the instruction stored in the instruction cache 314 is added to a scoreboard 322 that tracks the instructions that are in flight, i.e., instructions that have been issued but have not completed, and placed in the empty space of the instruction buffer 310, the instruction undergoes a decode 316.

The instruction dispatch unit 212 further includes an issue logic 320. The issue logic 320 examines the scoreboard 322 and issues an instruction out of the instruction buffer 310 that is not dependent on any of the instructions in flight. In conjunction with the issuance out of the instruction buffer 310, the issue logic 320 sends pipeline configuration signals to the appropriate execution pipeline.

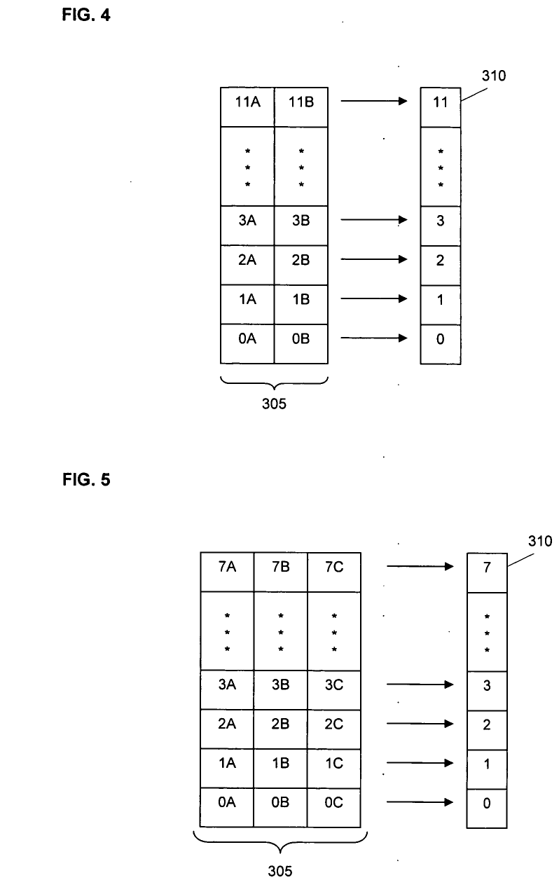

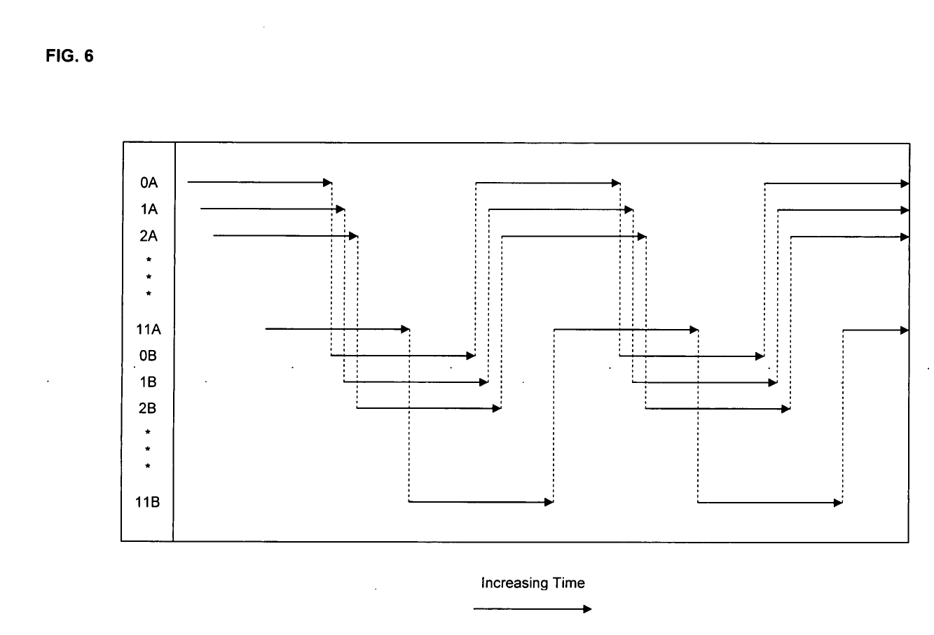

FIG. 4 illustrates the configuration of the thread pool 305 according to a first embodiment of the present invention. The thread pool 305 is configured as a table that has 12 rows and 2 columns. Each cell of the table represents a memory slot that stores a thread. Each row of the table represents a buddy group. Thus, the thread in cell 0A of the table is a buddy of the thread in cell 0B of the table. According to embodiments of the present invention, only one thread of a buddy group is active at a time. During instruction fetch, an instruction from an active thread is fetched. The fetched instruction subsequently undergoes a decode and stored in a corresponding slot of the instruction buffer 310. In the embodiment of the present invention illustrated herein, an instruction fetched from either cell 0A or cell 0B of the thread pool 305 is stored in slot 0 of the instruction buffer 310, and an instruction fetched from either cell 1A or cell 1B of the thread pool 305 is stored in slot 1 of the instruction buffer 310, and so forth. Also, the instructions stored in the instruction buffer 310 are issued in successive clock cycles according to the issue logic 320. In a simplified example shown in FIG. 6, the instructions stored in the instruction buffer 310 are issued in successive clock cycles beginning with the instruction in row 0 and then the instruction in row 1 and so forth.

FIG. 5 illustrates the configuration of the thread pool 305 according to a second embodiment of the present invention. The thread pool 305 is configured as a table that has 8 rows and 3 columns. Each cell of the table represents a memory slot that stores a thread. Each row of the table represents a buddy group. Thus, the threads in cells 0A, 0B and 0C of the table are considered buddy threads. According to embodiments of the present invention, only one thread of a buddy group is active at a time. During instruction fetch, an instruction from an active thread is fetched. The fetched instruction subsequently undergoes a decode and is stored in a corresponding slot of the instruction buffer 310. In the embodiment of the present invention illustrated herein, an instruction fetched from cell 0A, cell 0B or cell 0C of the thread pool 305 is stored in slot 0 of the instruction buffer 310, and an instruction fetched from either cell 1A, cell 1B or cell 1C of the thread pool 305 is stored in slot 1 of the instruction buffer 310, and so forth. Also, the instructions stored in the instruction buffer 310 are issued in successive clock cycles according to the issue logic 320.

When the thread pool 305 is populated with threads, it is loaded in column major order. Cell 0A is first loaded, followed by cell 1A, cell 2A, etc., until column A is filled up. Then, cell 0B is loaded, followed by cell 1B, cell 2B, etc., until column B is filled up. If the thread pool 305 is configured with additional columns, this thread loading process continues in the same manner until all columns are filled up. By loading the thread pool 305 in a column major order, buddy threads can be temporally separated as far as possible from one another. Also, each row of buddy threads is fairly independent of the other rows, such that the order between the rows is minimally enforced by the issue logic 320 when instructions are issued out of the instruction buffer 310.

FIG. 6 is a timing diagram that illustrates the swapping of active execution threads in the case where there are two buddy threads per group. The solid arrows correspond to a sequence of instructions that are executed for an active thread. The timing diagram shows that the thread in cell 0A of the thread pool 305 is initiated first and a sequence of instructions from that thread is executed until a swap instruction is issued from that thread. When the swap instruction is issued, the thread in cell 0A of the thread pool 305 goes to sleep (i.e., made inactive) and its buddy thread, i.e., the thread in cell 0B of the thread pool 305 is made active. Thereafter, a sequence of instructions from the thread in cell 0B of the thread pool 305 is executed until a swap instruction is issued from that thread. When this swap instruction is issued, the thread in cell 0B of the thread pool 305 goes to sleep and its buddy thread, i.e., the thread in cell 0A of the thread pool 305 is made active. This continues until both threads complete their execution. A swap to a buddy thread is also made when a thread has completed execution but its buddy thread has not.

As shown in FIG. 6, the other active threads of the thread pool 305 are initiated in succession after the thread in cell 0A. As with the thread in cell 0A, each of the other active threads is executed until a swap instruction issued from that thread, at which time that thread goes to sleep and its buddy thread is made active. The active execution then alternates between the buddy threads until both threads complete their execution.

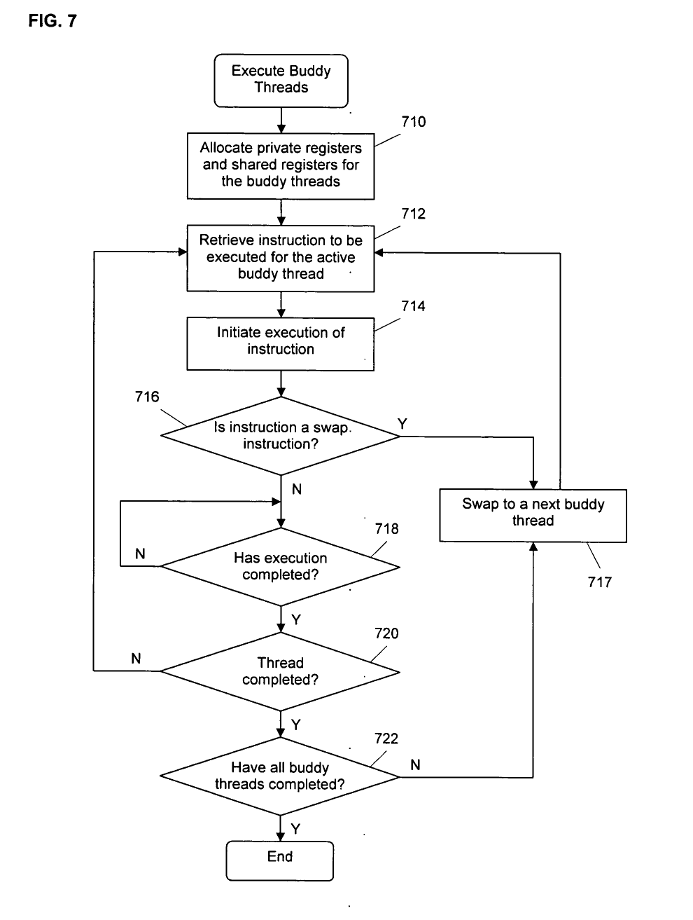

FIG. 7 is a flow diagram that illustrates the process steps carried out by a processing unit when executing threads in a buddy group (or buddy threads, for short). In step 710, hardware resources, in particular registers, for the buddy threads are allocated. The allocated registers include private registers for each of the buddy threads and shared registers to be shared by the buddy threads. The allocation of shared registers conserves register usage. For example, if there are two buddy threads and 24 registers are required by each of the buddy threads, a total of 48 registers would be required to carry out the conventional multi-processing method. In the embodiments of the present invention, however, shared registers are allocated. These registers correspond to those registers that are needed when a thread is active but not needed when a thread is inactive, e.g., when a thread is waiting to complete a long latency operation. Private registers are allocated to store any information that needs to be preserved in between swaps. In the example where 24 registers are required by each of the two buddy threads, if 16 of these registers can be allocated as shared registers, a total of only 32 registers would be required to execute both buddy threads. If there are three buddy threads per buddy group, the savings are even greater. In this example, a total of 40 registers would be required with the present invention, as compared to a total of 72 registers with the conventional multi-processing method.

One of the buddy threads starts out as being the active thread and an instruction from that thread is retrieved for execution (step 712). In step 714, the execution of the instruction retrieved in step 712 is initiated. Then, in step 716, the retrieved instruction is examined to see if it is a swap instruction. If it is a swap instruction, the current active thread is made inactive and one of the other threads in the buddy group is made active (step 717). If it is not a swap instruction, the execution initiated in step 714 is examined for completion (step 718). When this execution completes, the current active thread is examined to see if there are any remaining instructions to be executed (step 720). If there are, the process flow returns to step 712, where the next instruction to be executed is retrieved from the current active thread. If not, a check is made to see if all buddy threads have completed execution (step 722). If so, the process ends. If not, the process flow returns to step 717, where a swap is made to a buddy thread that has not completed.

In the embodiments of the present invention described above, the swap instructions are inserted when the program is compiled. A swap instruction is typically inserted right after a high latency instruction, and preferably at points in the program where a large number of shared registers, relative to the number of private registers, can be allocated. For example, in graphics processing, a swap instruction would be inserted right after a texture instruction. In alternative embodiments of the present invention, the swap event may not be a swap instruction but it may be some event that the hardware recognizes. For example, the hardware may be configured to recognize long latencies in instruction execution. When it recognizes this, it may cause the thread that issued the instruction causing the long latency to go inactive and make active another thread in the same buddy group. Also, the swap event may be some recognizable event during a long latency operation, e.g., a first scoreboard stall that occurs during a long latency operation.

The following sequence of instructions illustrates where in a shader program the swap instruction might be inserted by the compiler:

| | | | |
|---|---|---|---|
| Inst_00: | Interpolate | iw | |
| Inst_01: | Reciprocal | w | |
| Inst_02: | Interpolate | s, w | |
| Inst_03 | Interpolate | t, w | |
| Inst_04: | Texture | s, t | // Texture returns r, g, b, a values |
| Inst_05: | Swap | | |
| Inst_06: | Multiply | r, r, w | |
| Inst_07: | Multiply | g, g, w | |

The swap instruction (Inst_{—}05) is inserted right after the long latency Texture instruction (Inst_{—}04) by the compiler. This way, the swap to a buddy thread can be made while the long latency Texture instruction (Inst_{—}04) is executing. It is much less desirable to insert the swap instruction after the Multiply instruction (Inst_{—}06), because the Multiply instruction (Inst_{—}06) is dependent on the results of the Texture instruction (Inst_{—}04) and the swap to a buddy thread cannot be made until after the long latency Texture instruction (Inst_{—}04) completes its execution.

For simplicity of illustration, a thread as used in the above description of the embodiments of the present invention represents a single thread of instructions. However, the present invention is also applicable to embodiments where like threads are grouped together and the same instruction from this group, also referred to as a convoy, is processed through multiple, parallel data paths using a single instruction, multiple data (SIMD) processor.

While the foregoing is directed to embodiments of the present invention, other and further embodiments of the invention may be devised without departing from the basic scope thereof. The scope of the present invention is determined by the claims that follow.

What is claimed is:

1. A method of executing multiple threads of instructions in a processing unit, comprising the steps of:
allocating first, second and shared sets of hardware resources of the processing unit to first and second threads of instructions;
executing the first thread of instructions using the first and shared sets of hardware resources until occurrence of a predetermined event; and
in response to the occurrence of the predetermined event, suspending the execution of the first thread of instructions and executing the second thread of instructions using the second and shared sets of hardware resources.

2. The method according to claim 1, wherein the second thread of instructions is executed until occurrence of another predetermined event, and in response to the occurrence of said another predetermined event, the execution of the second thread of instructions is suspended and the execution of the first thread of instructions is resumed.

3. The method according to claim. 2, wherein the first thread of instructions comprises a swap instruction and the predetermined event occurs when the swap instruction in the first thread is executed, and wherein the second thread of instructions comprises a swap instruction and said another predetermined event occurs when the swap instruction in the second thread is executed.

4. The method according to claim 1, further comprising the step of allocating a third set of hardware resources and said shared set of hardware resources to a third thread of instructions, wherein the second thread of instructions is executed until occurrence of another predetermined event, and in response to the occurrence of said another predetermined event, the execution of the second thread of instructions is suspended and the third thread of instructions is executed.

5. The method according to claim 1, wherein the predetermined event occurs when a high latency instruction in the first thread of instructions is executed.

6. The method according to claim 5, wherein the high latency instruction comprises a memory access instruction.

7. The method according to claim 1, wherein the hardware resources comprise registers.

8. The method according to claim 7, wherein the hardware resources further comprise an instruction buffer.

9. The method according to claim 1, further comprising:
allocating third, fourth and fifth sets of hardware resources of the processing unit to third and fourth threads of instructions;
executing the third thread of instructions using the third and fifth sets of hardware resources until occurrence of a swap event for the third thread; and
in response to the occurrence of the swap event for the third thread, suspending the execution of the third thread of instructions and executing the fourth thread of instructions using the fourth and fifth sets of hardware resources.

10. The method according to claim 9, wherein the fourth thread of instructions is executed until occurrence of a swap event for the fourth thread, and in response to the occurrence of the swap event for the fourth thread, the execution of the fourth thread of instructions is suspended and the execution of the third thread of instructions is resumed.

11. In a processing unit having at least a first execution pipeline for executing math operations and a second execution pipeline for executing memory operations, a method of executing a group of threads of instructions in the execution pipelines, comprising the steps of:
executing a first thread of instructions from the group one instruction at a time; and
when an instruction in the first thread is executed in the second execution pipeline, suspending execution of further instructions in the first thread and executing a second thread of instructions from the group one instruction at a time.

12. The method according to claim 11, further comprising the step of: when an instruction in the second thread is executed in the second execution pipeline, suspending execution of further instructions in the second thread and executing a third thread of instructions from the group one instruction at a time.

13. The method according to claim 12, wherein the instructions included in the first, second and third threads and the sequence thereof are the same.

14. The method according to claim 11, further comprising the step of: when an instruction in the second thread is executed in the second execution pipeline, suspending execution of further instructions in the second thread and resuming execution of the further instructions in the first thread.

15. The method according to claim 11, wherein the first thread of instructions comprises a swap instruction that follows the instruction in the first thread that is executed in the second execution pipeline, and wherein the swap instruction causes the execution of further instructions in the first thread to be suspended and the execution of the second thread of instructions from the group to be carried out one instruction at a time.

16. A computer system comprising:
a memory unit for storing multiple threads of instructions and grouping the multiple threads of instructions into at least a first group and a second group; and
a processing unit programmed to (i) execute a thread of instructions from the first group until occurrence of a predetermined event, and (ii) upon occurrence of the predetermined event, suspend execution of the thread of instructions from the first group and carry out execution of a thread of instructions from the second group.

17. The computer system according to claim 16, wherein the number of threads of instructions in the first group is the same as the number of threads of instructions in the second group.

18. The computer system according to claim 16, wherein the processing unit comprises first and second execution pipelines, and each instruction in the multiple threads of instructions is executed in one of the first and second execution pipelines.

19. The computer system according to claim 18, wherein math instructions are executed in the first execution pipeline and memory access instructions are executed in the second execution pipeline.

20. The computer system according to claim 16, wherein the memory unit is configured to provide a third group of threads of instructions and the processing unit is programmed to (i) execute a thread of instructions from the second group until occurrence of another predetermined event, and (ii) upon occurrence of said another predetermined event, suspend execution of the thread of instructions from the second group and carry out execution of a thread of instructions from the third group.
